(19) United States
(12) Patent Application Publication
(10) Pub. No.: US 2018/0232774 A1
(43) Pub. Date: Aug. 16, 2018

(54) CONTEXTUAL RELEVANCE BRAND PROMOTION

(71) Applicant: International Business Machines Corporation, Armonk, NY (US)

(72) Inventor: Tinny M.C. Ng, Toronto (CA)

(21) Appl. No.: 15/434,185

(22) Filed: Feb. 16, 2017

(51) Int. Cl. G06Q 30/02

(52) U.S. Cl. CPC G06Q 30/0269; G06Q 30/0261

(57) ABSTRACT

Based on derived subject context of a user from subject data collected, analytics can match the subject context such as User Status with Item Usage Situation, and User Goal based on subject data with item data context functions such as Item Purpose, and User Sentiments with Item Sentiments Addressed. Based on a product that matches at least one and preferably two of the derived subject contexts, the right brand, which is contextually relevant to the customer or user at that point in time or in real time, can be recommended to the user.

### BACKGROUND

The present invention relates to contextual relevance of data, and more specifically to contextual relevance brand promotion.

An enterprise has many brands that can be offered to their customers and the enterprise can have difficulty targeting the right brand to the right customer at the right time. The enterprise may market certain brands targeting different groups of customers based on survey and statistics. However, it is very difficult to market specific brands to a specific customer at a specific time based on their context in the immediate time when the user needs a product associated with a particular brand.

### SUMMARY

According to one embodiment of the present invention a method of determining contextual relevance brand promotion for a user is disclosed. The method comprising the steps of: a computer generating and maintaining a product database categorizing brand items into contextual functions; the computer collecting, for each user, data regarding the user from devices of the user; the computer generating a user context based on the data collected from the devices of the user comprising user status, user goals and user sentiments in real time; the computer comparing the generated user context to contextual functions of brand items in the product database to identify at least one contextually relevant product to recommend to the user; and the computer sending a promotion for the contextually relevant product applicable to the user in real time.

According to another embodiment, a computer program product for determining contextual relevance brand promotion for a user is disclosed. The computer program product comprising a computer comprising at least one processor, one or more memories, one or more computer readable storage media, the computer program product comprising a computer readable storage medium having program instructions embodied therewith. The program instructions executable by the computer to perform a method comprising: generating and maintaining, by the computer, a product database categorizing brand items into contextual functions; collecting, by the computer, for each user, data regarding the user from devices of the user; generating, by the computer, a user context based on the data collected from the devices of the user comprising user status, user goals and user sentiments in real time; comparing, by the computer, the generated user context to contextual functions of brand items in the product database to identify at least one contextually relevant product to recommend to the user; and sending, by the computer, a promotion for the contextually relevant product applicable to the user in real time.

According to another embodiment, a computer system for determining contextual relevance brand promotion for a user is disclosed. The computer system comprising a computer comprising at least one processor, one or more memories, one or more computer readable storage media having program instructions executable by the computer to perform the program instructions. The program instructions comprising: generating and maintaining, by the computer, a product database categorizing brand items into contextual functions; collecting, by the computer, for each user, data regarding the user from devices of the user; generating, by the computer, a user context based on the data collected from the devices of the user comprising user status, user goals and user sentiments in real time;

comparing, by the computer, the generated user context to contextual functions of brand items in the product database to identify at least one contextually relevant product to recommend to the user; and sending, by the computer, a promotion for the contextually relevant product applicable to the user in real time.

### BRIEF DESCRIPTION OF THE DRAWINGS

FIG. 1 depicts an exemplary diagram of a possible data processing environment in which illustrative embodiments may be implemented.

FIG. 2 shows an exemplary diagram of an Internet of Things (IoT) foundation.

FIG. 3 shows an exemplary diagram of an analytics engine.

FIG. 4 shows an exemplary diagram of a database of the data processing environment.

FIG. 5 shows a flow diagram of a method of determining contextual relevance brand promotion for a user.

FIG. 6 illustrates internal and external components of devices of FIG. 1 in which illustrative embodiments may be implemented.

### DETAILED DESCRIPTION

In one embodiment of the present invention, it is recognized that, based on derived subject context, analytics can match the subject context based on subject data with item data context functions. Some examples include User Status with Item Usage Situation, User Goal with Item Purpose, and User Sentiments with Item Sentiments Addressed. Based on a product that matches at least one and preferably two of the derived subject contexts, the right brand, which is contextually relevant to the customer or user at that point in time or in real time, can be recommended to the user.

It will also be recognized that the item data is not categorized by general product specification (i.e. mineral, vitamin, food type, etc.), but is categorized by contextual functions, such as Usage situation, Purpose, and Sentiments Addressed. The recommendation of a brand which is relevant to the user or customer is provided at the moment in which the user has the appropriate situation or User status, user need (user goal) and user sentiment.

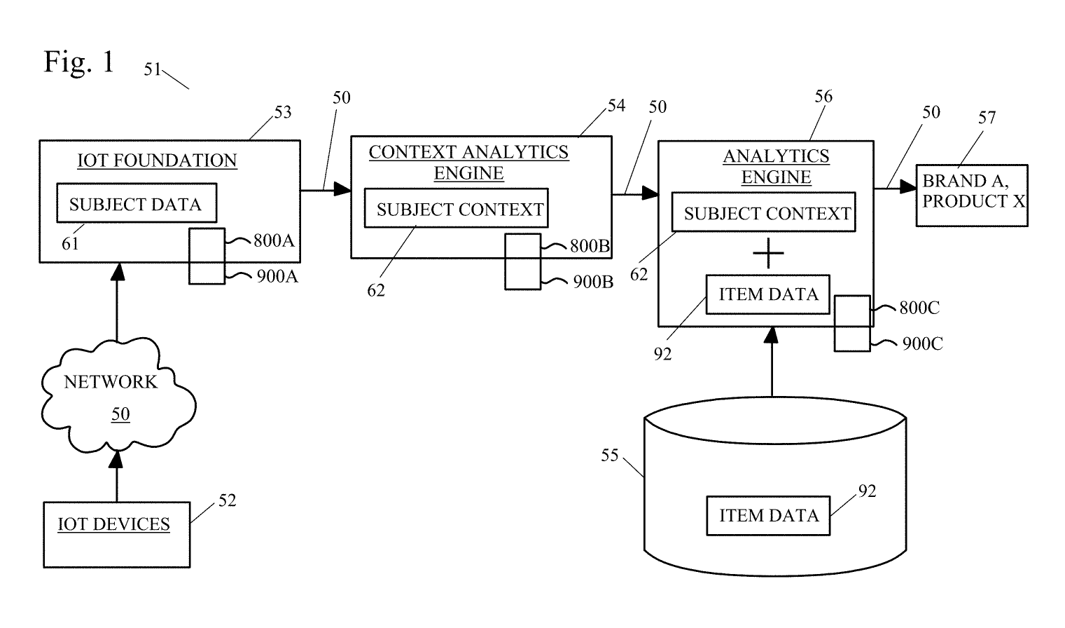

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

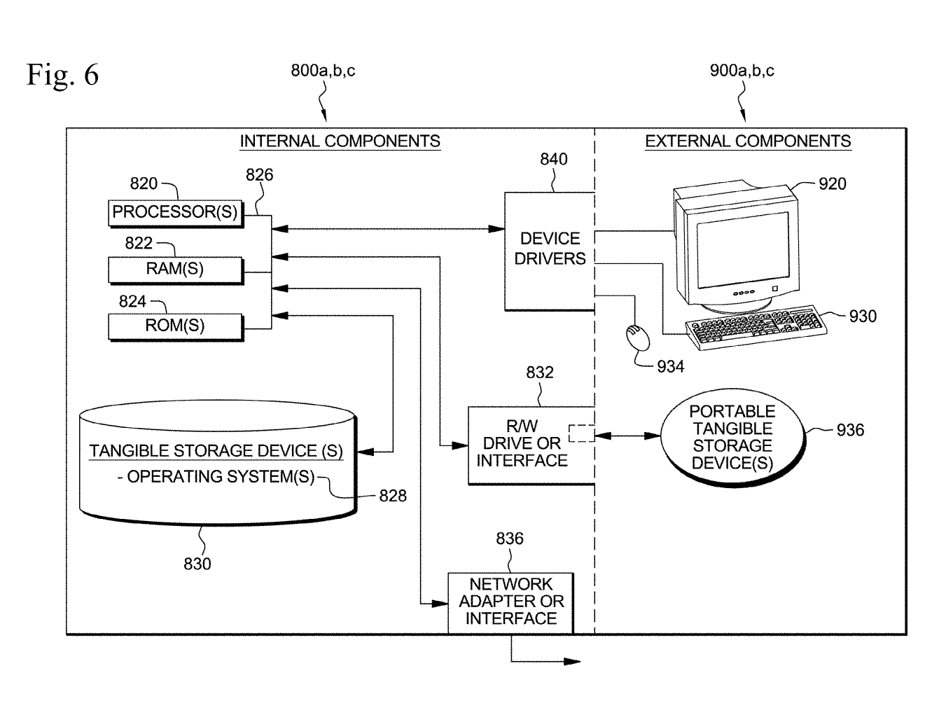

In the depicted example, IoT devices 52 are connected through the network 50 to an IoT foundation 53. The IoT devices 52 may be any device with a sensor which tracks data related to the user of the device or subject data 61. The IoT devices 52 may be, but are not limited to, any combination of mobile devices, smartwatches, fitness trackers, smart glasses, smart clothing and other wearables. The IoT devices 52 include a set of internal and external components such as internal components 800a and a set of external components 900a, further illustrated in FIG. 6.

The IoT foundation 53 is also connected to a context analytics engine 54 through the network 50.

The context analytics engine 54 determines subject context data 62 from the subject data 61 of the user received from the IoT devices 52. The context analytics engine 54 is connected to an analytics engine 56 through the network 50. The context analytics engine uses the subject context data 62 and item data 92, which is data regarding the items of brands of products from the database 55, to determine a brand of a product 57 which is applicable to the user at a specific moment in time. The specific moment in time is preferably relevant to the user at the present time or within a time period relative to the received subject data of the user. The database 55 is connected to the context analytics engine 54.

In other exemplary embodiments, network data processing system 51 may include additional client or device computers, storage devices or repositories, server computers, and other devices not shown.

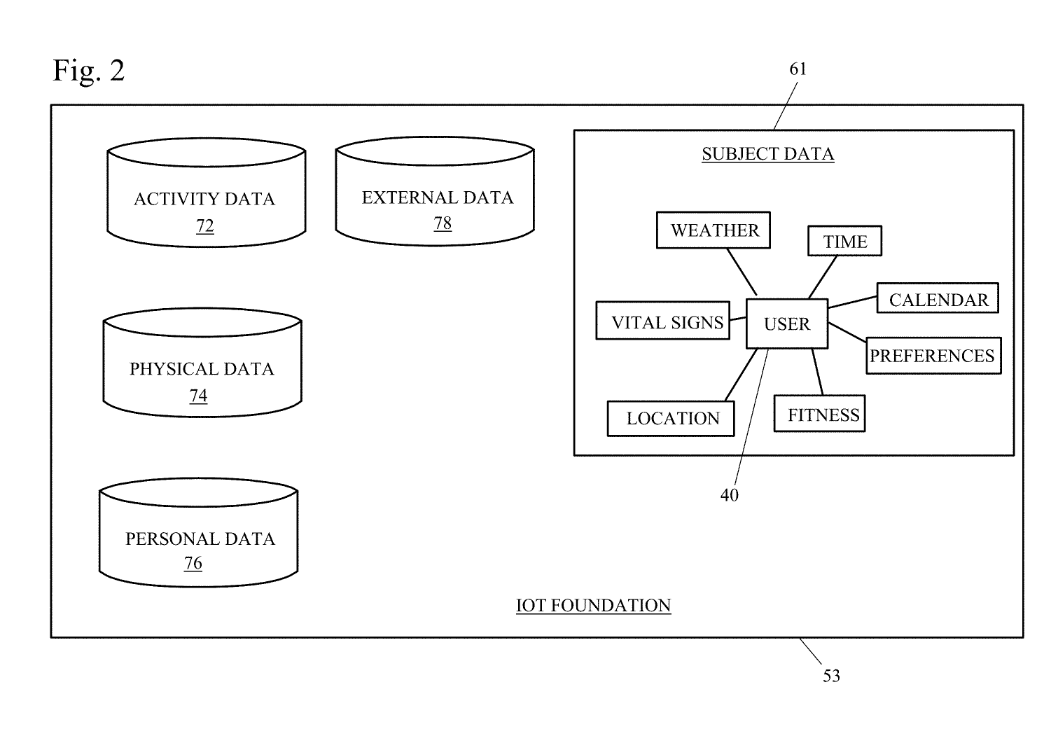

Referring to FIG. 2, the IoT foundation 53 includes databases with data regarding the user received from the IoT devices 52. The subject data 61 received from the IoT devices 52 may include, but is not limited to, location of the user, weather at the location of the user, vital signs of the user, time, calendar, and fitness of the user 40. The databases in which the data is stored may include, but are not limited to, activity data 72, physical data 74, personal data 76, and external data 78. The IoT foundation 53 includes a set of internal components 800b and a set of external components 900b, further illustrated in FIG. 6.

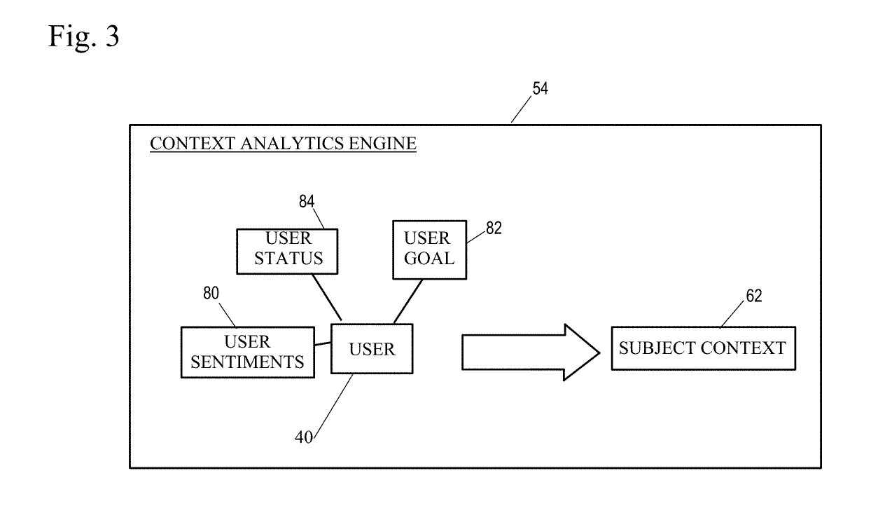

Components of the context analytics engine 54 are shown in FIG. 3. The context analytics engine 54 generates subject context 62 for the user based on user status 84, user sentiments 80 and user goals 82 as derived from the subject data 61 received from the IoT foundation 53. The subject context 62 is sent to the analytics engine 56. The context analytics engine 54 includes a set of internal components 800b and a set of external components 900b, further illustrated in FIG. 6.

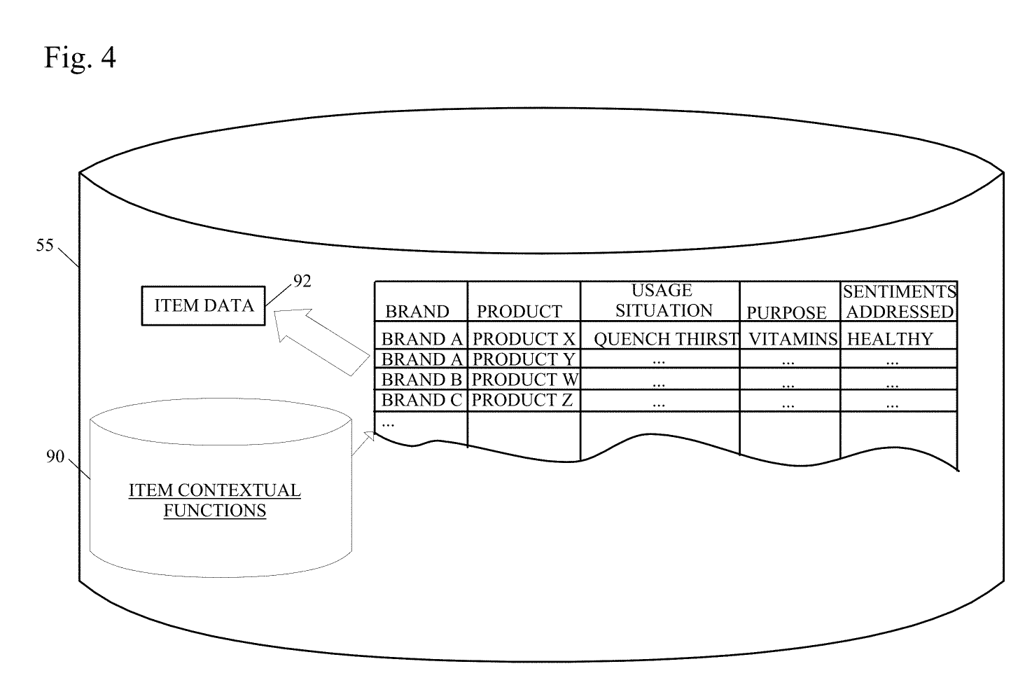

Referring to FIG. 4, the database 55, which provides input to the analytics engine 56, preferably includes an item contextual functions database 90. The item contextual functions database 90 has item or product data 92 which includes, but is not limited to, corresponding information regarding the products, and is categorized into contextual functions such as usage situation, sentiments addressed and purpose of the product or item. The product or item data 92 may also include a location and price as to where the product can be purchased by the user.

The analytics engine 56, which is connected to the context analytics engine 54, uses the subject context data 62 and the item data 91 to determine the brand and product to recommend to the user when relevant to the user within a time period of receiving the subject data of the user. The recommendation may be sent to the user via the IoT devices 52. The analytics engine 56 includes a set of internal components 800c and a set of external components 900c, further illustrated in FIG. 6.

In the depicted example, network data processing system 51 is the Internet with network 50 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 51 also may be implemented as a number of different types of networks, such as, for example, an intranet, local area network (LAN), or a wide area network (WAN). FIG. 1 is intended as an example, and not as an architectural limitation, for the different illustrative embodiments.

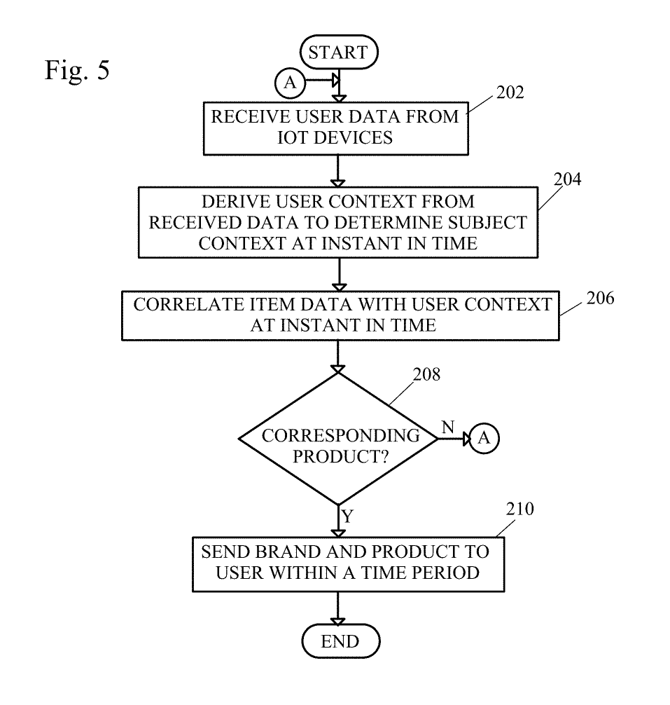

FIG. 5 shows a flow diagram of a method of determining contextual relevance brand promotion for a user.

User data is received from at least two IoT devices of the user (step 202). The user data may include, but is not limited to, personal data such as location of the user, address of the user, size of the user, electronic calendar of the user or others, preferences; physical data such as vital signs of the user, glucose levels, heart rate, body temperature; activity data such as fitness of the user, and activity the user is engaged in; external data such as location of the user, time, traffic in the location of the user, news regarding the location of the user, and weather at the location of the user.

User data received from the IoT devices of the user is used to derive user context at an instant in time (step 204). The user data may be characterized relative to context, such as user status, user goals and user sentiments by the context analytics engine 54. The context analytics engine can use a set of rules, such as rules engine that maps conditions to a conclusion. For example:

Rule 1: If body temperature from physical data is greater than 37° C., then user status is “has fever”
Rule 2: If activity data indicates a user is sleeping and is user state is “has fever”, then user sentiment is “unwell”.
Rule 3: If the user status is “has fever” and user sentiment is “unwell” then user goal can be set to “need to replenish vitamin level”.
Therefore, the user context for the user may be User status: Has Fever; User sentiment: Unwell; User goal: replenish vitamin level.

Other analytics engines may also be used to derive user context, such as smart data analysis and visualization service on a cloud to discover patterns and meanings in data.

Item data which corresponds to the user context in an instant of time is determined (step 206), for example by the analytics engine 56 with the subject context data 62 received from the context analytics engine 54 and the item data 92 received from the database 55.

If characteristics of corresponding brand and associated product are found, where at least some of the characteristics are similar to at least some of the user's context data based on the subject data of the user (step 208), such as user status, user goals and user sentiment, a brand and associated product are sent to the user (step 210) and the method ends. The brand and associated product can be sent to the user via the IoT devices when the user is determined to need the product, providing at least one contextual relevance brand promotion to users in real time. The brand and associated product may also be automatically sent within a time period from when the data was received from the IoT devices. The time period may be within 1 to 10 minutes of receiving the subject data of the user, but is preferably when the recommendation of a brand is relevant to the user or customer since the user has the appropriate situation or User status, user need (user goal) and user sentiment. The recommendation of a brand and associated product is based on the analytical correlation and matching of subject context of the user with item data which has been categorized on contextual function. The recommendation of a brand and associated product is not based upon the likelihood of the user to accept the offer of purchasing the product.

If characteristics of a corresponding brand and associated product are not found, the method returns to step 202 of receiving user data from IoT devices.

### Example 1

A Beverage Company has numerous brands, Brand A for sports drinks, Brand B for spring water, Brand C for vitamin containing beverages and Brand D for carbonated beverages. The database associated with the Beverage Company has each of the brands associated with contextual function. For example, the database may include the following information:

1. Brand C—Vitamin containing beverages
Usage situation: Sick, Exercise, Health Protection
Purpose: Replenish vitamin Level
Sentiment addressed: Not feeling well, Weak

2. Brand A—Sports Drink
Usage situation: Exercise, Working
Purpose: Replenish energy Level
Sentiment addressed: Tired, Exhausted

3. Brand B—Spring Water
Usage situation: Anytime, Dehydrating
Purpose: Replenish water Level
Sentiment addressed: Thirsty

4. Brand D—Carbonated Beverages
Usage situation: Anytime, Party
Purpose: Have fun, party drink
Sentiment addressed: Happy

User 1 has been exercising for two hours as indicated by the IoT devices of the user which send subject data to the IoT foundation, such as location, vitals of the user, and fitness of the user (steps taken, pace of steps taken). The subject data is stored in the appropriate repositories 72-78 of the IoT foundation. The subject data based on the data collected from the IoT devices of the user is “working out for more than 2 hours”.

The context analytics engine analyzes the subject data and determines the following subject context:
User status: Exercising
User sentiment: Tired
User goal: Need to replenish energy level

The analytics engine then correlates the “Subject Context” and “Item Data” to find at least one of user sentiment, user status or user goal which is commonly shared between the subject context and the item data for the brand.

Based on the subject context of “working out for more than 2 hours” and the item data above, Brand A—Sports Drink would be recommended to the user. The recommendation may include promotional information. The recommendation may also be received by the user when the user would need the product, for example after completing their exercise program.

### Example 2

Referring to the same Beverage Company as in Example 1, the same User is feeling unwell. The vital signs of the user, as collected by the IoT device, indicate that the user's body temperature is over 37 degrees Celsius. Other subject data such as location and fitness may also be sent to the IoT foundation. The subject data is stored in appropriate repositories 72-78 of the IoT foundation. The subject data is therefore “body temperature is over 37° C”. Other subject data such as location, and fitness of the user may also be used to determine that the user is at home.

The context analytics engine analyzes the subject data and determines the following subject context:
User status: Have a fever
User sentiment: Not feeling well
User goal: Need to replenish vitamin level

The analytics engine then correlates the “Subject Context” and “Item Data” to find at least one of user sentiment, user status or user goal which is commonly shared between the subject context and the item data for the brand.

Based on the subject context of “body temperature is over 37° C.” and the item data above, Brand C—Vitamin containing beverage would be recommended to the user. The recommendation may include promotional information. The recommendation may also be received by the user when the user would need the product.

### Example 3

Referring to the same Beverage Company as in Example 1, the same User is walking around outside in the sun. The user's phone, and IoT device, detects the weather temperature to be over 32° C. An IoT device of the user also determines that the user's location is at a park and another IoT device has collected data indicating that the user has been moving or walking for two hours. The subject data of external data of “temperature is over 32° C.” plus activity data of “walking outdoors for two hours” is collected. The subject data is stored in appropriate repositories 72-78 of the IoT foundation. Other subject data such as location, and vital signs of the user may also provide information regarding the user.

The context analytics engine analyzes the subject data and determines the following subject context:
User status: Walking
User sentiment: Dehydrating. Feeling Hot
User goal: Need to replenish water level

The analytics engine then correlates the “Subject Context” and “Item Data” to find at least one of user sentiment, user status or user goal which is commonly shared between the subject context and the item data for the brand.

Based on the subject context of “external temperature is over 32° C.” and “walking outdoors for two hours” and the item data above, Brand B—Spring Water would be recommended to the user. The recommendation may include promotional information. The recommendation may also be received by the user when the user would need the product.

### Example 4

Referring to the same Beverage Company as in Example 1, the calendar on one of the IoT devices of the user indicates that the user is hosting a party at his home. The subject data of personal data of “having a party tonight” is collected. The subject data is stored in appropriate repositories 72-78 of the IoT foundation. Other subject data such as location may also provide information regarding the user.

The context analytics engine analyzes the subject data and determines the following subject context:
User status: Going to have party
User sentiment: Happy
User goal: Need to buy drinks for party

The analytics engine then correlates the “Subject Context” and “Item Data” to find at least one of user sentiment, user status or user goal which is commonly shared between the subject context and the item data for the brand.

Based on the subject context of “having a party tonight” and the item data above, Brand D—Carbonated Beverages would be recommended to the user. The recommendation may include promotional information. The recommendation may also be received by the user when the user would need the product.

It should be noted that while beverages were used in the examples above, the system target is not limited to beverages and can be applicable to other foods as well as products other than food.

FIG. 6 illustrates internal components 800a, 800b, 900c and external components 900a, 900b, 900c of an IoT foundation 53, context analysis engine 54, analytics engine 56 and IoT devices 52 in which illustrative embodiments may be implemented. Each of the sets of internal components 800a, 800b, 800c includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 are stored on one or more of the computer-readable tangible storage devices 830 for execution by one or more of the processors 820 via one or more of the RAMs 822 (which typically include cache memory). In the embodiment illustrated in FIG. 6, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b, 800c also includes a R/W drive or interface 832 to read from and write to one or more portable computer-readable tangible storage devices 936 such as a CD-ROM, DVD, memory stick, magnetic tape, magnetic disk, optical disk or semiconductor storage device.

Each set of internal components 800a, 800b, 800c also includes a network adapter or interface 836 such as a TCP/IP adapter card. Programs and operating systems can be downloaded to the IoT Foundation 53, context analytics engine 54, and analytics engine 56 from an external computer via a network (for example, the Internet, a local area network or other, wide area network) and network adapter or interface 836. From the network adapter or interface 836, programs and operating systems are loaded into hard drive 830. Programs and operating systems can be downloaded to the IoT Foundation 53, context analytics engine 54, and analytics engine 56 from an external computer via a network (for example, the Internet, a local area network or other, wide area network) and network adapter or interface 836. From the network adapter or interface 836, programs and an operating system are loaded into hard drive 830. The network may comprise copper wires, optical fibers, wireless transmission, routers, firewalls, switches, gateway computers and/or edge servers.

Each of the sets of external components 900a, 900b, 900c can include a computer display monitor 920, a keyboard 930, and a computer mouse 934. Each of the sets of internal components 800a, 800b, 800c also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of determining contextual relevance brand promotion for a user comprising the steps of:
a computer generating and maintaining a product database categorizing brand items into contextual functions;
the computer collecting, for each user, data regarding the user from devices of the user;
the computer generating a user context based on the data collected from the devices of the user comprising user status, user goals and user sentiments in real time;
the computer comparing the generated user context to contextual functions of brand items in the product database to identify at least one contextually relevant product to recommend to the user; and
the computer sending a promotion for the contextually relevant product applicable to the user in real time.

2. The method of claim 1, wherein the contextual functions of the products of each brand comprises usage situation, purpose and sentiments addressed.

3. The method of claim 1, wherein the data collected from the user is collected using at least one Internet of Things device.

4. The method of claim 1, wherein the data collected from the user comprises activity data of the user of an activity being performed by the user, physical data of the user, external data and personal data.

5. The method of claim 4, wherein the personal data comprises: address of the user, size of the user, location of the user, and data present within an electronic calendar of the user.

6. The method of claim 4, wherein the external data comprises: data regarding the environment comprising: time of day at a location, traffic in a location of the user, news regarding the location of the user, and weather at the location of the user.

7. The method of claim 4, wherein the physical data comprises: vital signs of the user, body temperature of the user, glucose levels, and activity the user is engaged in.

8. A computer program product for determining contextual relevance brand promotion for a user, a computer comprising at least one processor, one or more memories, one or more computer readable storage media, the computer program product comprising a computer readable storage medium having program instructions embodied therewith, the program instructions executable by the computer to perform a method comprising:
generating and maintaining, by the computer, a product database categorizing brand items into contextual functions;
collecting, by the computer, for each user, data regarding the user from devices of the user;
generating, by the computer, a user context based on the data collected from the devices of the user comprising user status, user goals and user sentiments in real time;
comparing, by the computer, the generated user context to contextual functions of brand items in the product database to identify at least one contextually relevant product to recommend to the user; and
sending, by the computer, a promotion for the contextually relevant product applicable to the user in real time.

9. The computer program product of claim 8, wherein the contextual functions of the products of each brand comprises usage situation, purpose and sentiments addressed.

10. The computer program product of claim 8, wherein the data collected from the user is collected using at least one Internet of Things device.

11. The computer program product of claim 8, wherein the data collected from the user comprises activity data of the user of an activity being performed by the user, physical data of the user, external data and personal data.

12. The computer program product of claim 11, wherein the personal data comprises address of the user, size of the user, location of the user, and data present within an electronic calendar of the user.

13. The computer program product of claim 11, wherein the external data comprises: data regarding the environment comprising: time of day at a location, traffic in a location of the user, news regarding the location of the user, and weather at the location of the user.

14. The computer program product of claim 11, wherein the physical data comprises: vital signs of the user, body temperature of the user, glucose levels, and activity the user is engaged in.

15. A computer system for determining contextual relevance brand promotion for a user comprising a computer comprising at least one processor, one or more memories, one or more computer readable storage media having program instructions executable by the computer to perform the program instructions comprising:
generating and maintaining, by the computer, a product database categorizing brand items into contextual functions;
collecting, by the computer, for each user, data regarding the user from devices of the user;
generating, by the computer, a user context based on the data collected from the devices of the user comprising user status, user goals and user sentiments in real time;
comparing, by the computer, the generated user context to contextual functions of brand items in the product database to identify at least one contextually relevant product to recommend to the user; and
sending, by the computer, a promotion for the contextually relevant product applicable to the user in real time.

16. The computer system of claim 15, wherein the contextual functions of the products of each brand comprises usage situation, purpose and sentiments addressed.

17. The computer system of claim 15, wherein the data collected from the user is collected using at least one Internet of Things device.

18. The computer system of claim 15, wherein the data collected from the user comprises activity data of the user of an activity being performed by the user, physical data of the user, external data and personal data.

19. The computer system of claim 18, wherein the personal data comprises: address of the user, size of the user, location of the user, and data present within an electronic calendar of the user.

20. The computer system of claim 18, wherein the external data comprises: data regarding the environment comprising: time of day at a location, traffic in a location of the user, news regarding the location of the user, and weather at the location of the user.
